(19) United States
(12) Patent Application Publication
(10) Pub. No.: US 2015/0112625 A1
(43) Pub. Date: Apr. 23, 2015

(54) TESTING APPARATUS AND METHOD FOR TESTING PRODUCT

(71) Applicant: Wistron Corporation, New Taipei City (TW)

(72) Inventor: Chun-Chih Lin, New Taipei City (TW)

(21) Appl. No.: 14/337,252

(22) Filed: Jul. 22, 2014

(30) Foreign Application Priority Data
Oct. 22, 2013 (TW) 102138145

(51) Int. Cl. G05B 19/048

(52) U.S. Cl. CPC G05B 19/048
USPC 702/83

(57) ABSTRACT

A testing apparatus and a method for testing products are provided. The method includes the following steps. First, a first testing procedure is performed to at least one product to be tested in response to a test starting command to test a plurality of first items to be tested of the at least one product. When the first testing procedure corresponding to the at least one product to be tested and a manual testing procedure of the at least one product to be tested are finished, a testing result of each of the at least one produce is reported. The manual testing procedure of each of the at least one product to be tested is configured to test a plurality of second items to be tested of the at least one product.

### CROSS-REFERENCE TO RELATED APPLICATION

This application claims the priority benefit of Taiwan application serial no. 102138145, filed on Oct. 22, 2013. The entirety of the above-mentioned patent application is hereby incorporated by reference herein and made a part of this specification.

### BACKGROUND

1. Technical Field

The invention relates to an apparatus and a testing method thereof. Particularly, the invention relates to a testing apparatus and a method for testing product.

2. Related Art

Generally, each product has to go through a certain testing flow during a production process thereof to ensure a normal operation of various functions of the product. For example, a network test, a firmware test, a hardware test, a memory test, a processing unit test, a key test, a display test of a monitor, a light-emitting test of a lamp, a headphone test, an earphone test, etc., which are all possible items to be tested.

Roughly speaking, test items of the product are approximately divided into auto test items and manual test items. The auto test items (for example, the memory test) could be automatically executed by a computer device connected to the product, and the manual test items (for example, the key test) generally require an operator to perform the test in a manual approach. However, in the conventional testing flow, execution of one of the auto or manual test items is performed only after execution of another test item is completed, which causes unnecessary waste of time.

Moreover, although all of the testing flows could be designed to be automatically executed according to the existing technique, when such method is used for testing products with different structures, a designer has to additionally design corresponding testing hardware, such that this kind of method is lack of flexibility in application. For example, when the designer designs corresponding automatic testing methods for telephones with different structures (for example, with different key positions), the designer probably has to design a hardware testing structure for each of the telephones, so that a manufacturing overhead for testing the products is accordingly increased.

### SUMMARY

The invention is directed to a testing apparatus and a method for testing product, by which an auto test and a manual test in a testing flow of the product are simultaneously started, so as to save a testing time.

The invention provides a method for testing product, which is adapted to a testing apparatus. The method includes the following steps. First, a test starting command is received. Then, a first testing procedure is performed to at least one product to be tested in response to the test starting command to test a plurality of first items to be tested of the at least one product to be tested. When the first testing procedure corresponding to the at least one product to be tested and a manual testing procedure of the at least one product to be tested are finished, a testing result of the at least one product to be tested is reported, where the manual testing procedure of the at least one product to be tested is configured to test a plurality of second items to be tested of the at least one product to be tested.

In an embodiment of the invention, a total testing time required by performing the first testing procedure to the at least one product to be tested and performing the manual testing procedure to the at least one product to be tested is equal to a testing time required by performing the manual testing procedure to the at least one product to be tested.

In an embodiment of the invention, at least a part of the first testing procedure of the at least one product to be tested and a part of the manual testing procedure of the at least one product to be tested are simultaneously performed.

In an embodiment of the invention, the step of performing the first testing procedure to the at least one product to be tested in response to the test starting command to test the first items to be tested of the at least one product to be tested includes simultaneously starting the first testing procedures corresponding to the at least one product to be tested.

In an embodiment of the invention, the step of performing the first testing procedure to the at least one product to be tested in response to the test starting command to test the first items to be tested of the at least one product to be tested includes sequentially starting the first testing procedures corresponding to the at least one product to be tested.

In an embodiment of the invention, the first testing procedures of the at least one product to be tested are partially overlapped in timing and are not ended simultaneously.

In an embodiment of the invention, the first testing procedures of the at least one product to be tested are partially overlapped in timing and are substantially ended simultaneously.

In an embodiment of the invention, the first testing procedures of the at least one product to be tested are not partially overlapped in timing and are not performed in immediate continuation.

In an embodiment of the invention, the first testing procedures of the at least one product to be tested are not partially overlapped in timing and are performed in immediate continuation.

In an embodiment of the invention, the step of sequentially starting the first testing procedures corresponding to the at least one product to be tested includes starting the first testing procedure corresponding to another product to be tested in the at least one product to be tested when the first testing procedure corresponding to one of the at least one product to be tested is finished.

In an embodiment of the invention, the step of performing the first testing procedure to the at least one product to be tested in response to the test starting command to test the first items to be tested of the at least one product to be tested includes increasing a testing strength of the first items to be tested when a first time required by the first testing procedure is smaller than a second time required by the manual testing procedure.

In an embodiment of the invention, the step of performing the first testing procedure to the at least one product to be tested in response to the test starting command to test the first items to be tested of the at least one product to be tested includes postponing execution of the first testing procedure such that a first ending time point of the first testing procedure is substantially the same to a second ending time point of the manual testing procedure when a first time required by the first testing procedure is smaller than a second time required by the manual testing procedure.

The invention provides a testing apparatus including a user interface, a storage unit and a processing unit. The user interface receives a test starting command. The storage unit stores a plurality of program codes. The processing unit is coupled to the user interface and the storage unit. The processing unit is configured to access the program codes to execute following steps. A first testing procedure is performed to at least one product to be tested in response to the test starting command to test a plurality of first items to be tested of the at least one product to be tested. When the first testing procedure corresponding to the at least one product to be tested and a manual testing procedure of the at least one product to be tested are finished, the processing unit reports a testing result of the at least one product to be tested, where the manual testing procedure of the at least one product to be tested is configured to test a plurality of second items to be tested of the at least one product to be tested.

In an embodiment of the invention, the processing unit substantially starts the first testing procedures corresponding to the at least one product to be tested, simultaneously.

In an embodiment of the invention, the processing unit sequentially starts the first testing procedures corresponding to the at least one product to be tested.

In an embodiment of the invention, when the first testing procedure corresponding to one of the at least one product to be tested is finished, the processing unit starts the first testing procedure corresponding to another product to be tested in the at least one product to be tested.

In an embodiment of the invention, when a first time required by the first testing procedure is smaller than a second time required by the manual testing procedure, the processing unit increases a testing strength of the first items to be tested.

In an embodiment of the invention, when a first time required by the first testing procedure is smaller than a second time required by the manual testing procedure, the processing unit postpones execution of the first testing procedure such that a first ending time point of the first testing procedure is substantially the same to a second ending time point of the manual testing procedure.

According to the above descriptions, according to the testing apparatus and the method for testing product of the invention, after the test starting command is received, the first testing procedure is automatically performed to the product to be tested, so as to automatically test the first items to be tested on the product to be tested. Meanwhile, the operator could perform the manual testing procedure to the product to be tested to manually test the second items to be tested on the product to be tested. In case that the first testing procedure and the manual testing procedure are substantially and simultaneously started, the time required by the whole process of testing the product to be tested is effectively reduced.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a testing apparatus according to an embodiment of the invention.

FIG. 2 is a flowchart illustrating a method for testing product according to an embodiment of the invention.

FIG. 3A is a schematic diagram of performing a first testing procedure and a manual testing procedure corresponding to a product to be tested according to an embodiment of the invention.

FIG. 3B is a schematic diagram of performing a first testing procedure and a manual testing procedure corresponding to a product to be tested according to an embodiment of the invention.

FIG. 3C is a schematic diagram of performing a first testing procedure and a manual testing procedure corresponding to a product to be tested according to an embodiment of the invention.

FIG. 4A to FIG. 4D are schematic diagrams of sequentially performing a first testing procedure according to a plurality of embodiments of the invention.

FIG. 5 is a schematic diagram of increasing a testing strength of first items to be tested of a product to be tested according to an embodiment of the invention.

FIG. 6 is a schematic diagram of postponing testing of first items to be tested of a product to be tested according to an embodiment of the invention.

### DETAILED DESCRIPTION OF DISCLOSED EMBODIMENTS

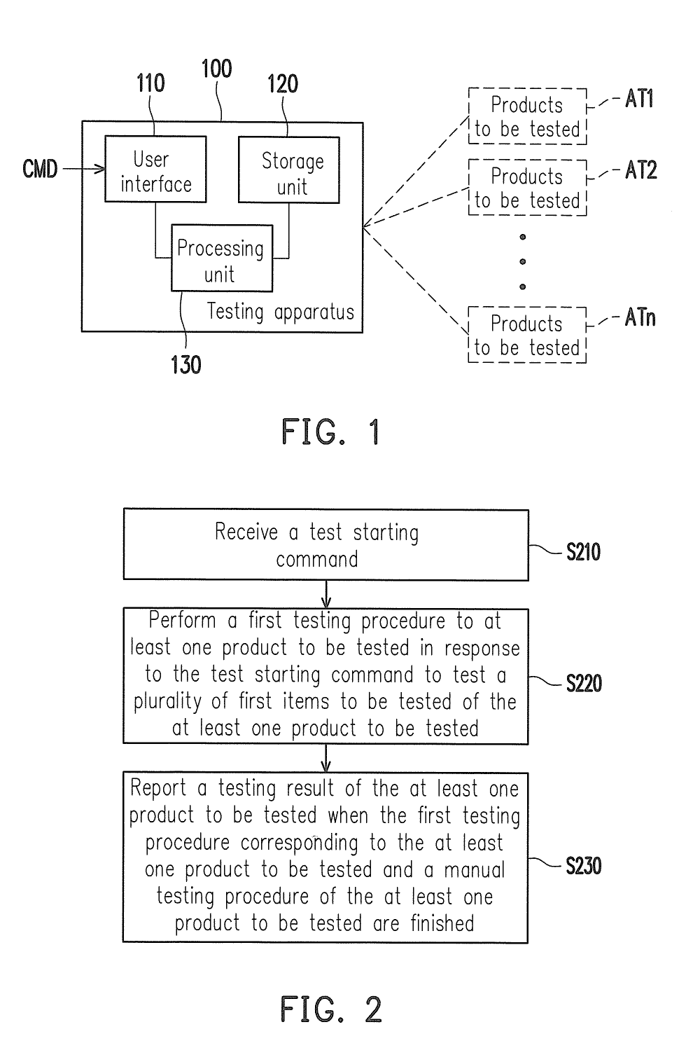

FIG. 1 is a schematic diagram of a testing apparatus according to an embodiment of the invention. In the present embodiment, a testing apparatus 100 includes a user interface 110, a storage unit 120 and a processing unit 130. The testing apparatus 100 is, for example, a personal computer (PC), a notebook PC), a netbook PC, a tablet PC or any computer device capable of connecting products to be tested AT1-ATn (n is a positive integer) through a transmission interface. The transmission interface could be a cable transmission interface, for example, RS-232, a universal serial bus (USB), an Ethernet, etc. Alternatively, the transmission interface could also be a wireless transmission interface, for example, a wireless fidelity (Wi-Fi) network interface, a wireless local area network (WLAN), etc., though the invention is not limited thereto. In other embodiments, the testing apparatus 100 could be connected to the products to be tested AT1-ATn through a hub, a switch or other similar devices.

The user interface 110 is, for example, a touch screen, a mouse, a keyboard or any device through which the user inputs commands to the testing apparatus 100 to control operations of the testing apparatus 100. The processing unit 130 is coupled to the user interface 110 and the storage unit 120. The storage unit 120 is, for example, a memory, a hard disk or any other device capable of storing data and/or program codes. The processing unit 130 is, for example, a general purpose processor, a special purpose processor, a conventional processor, a digital signal processor, a plurality of microprocessors, one or a plurality of microprocessors combined with digital signal processor core, a controller, a microcontroller, an application specific integrated circuit (ASIC), a field programmable gate array (FPGA), any other type of integrated circuit, a state machine, a processor based on an advanced RISC machine (ARM), etc.

FIG. 2 is a flowchart illustrating a method for testing product according to an embodiment of the invention. The method of the present embodiment is adapted to the testing apparatus 100 of FIG. 1, and the method is described in detail below with reference of various component of FIG. 1.

When an operator wants to test the products to be tested AT1-ATn by using the testing apparatus 100, the operator could input a test starting command CMD to the testing apparatus 100 through the user interface 110 (for example, a touch screen or a keyboard), so as to control the testing apparatus 100 to perform related testing operations. Therefore, in step S210, the user interface 110 receives the test starting command CMD.

Then, in step S220, the processing unit 130 performs a first testing procedure to each of the products to be tested AT1-ATn in response to the test starting command CMD to test a plurality of first items to be tested of each of the products to be tested AT1-ATn. The first items to be tested are, for example, a network test item, a firmware test item, a hardware information test item, a memory test item and/or a processing unit test item. For example, the processing unit 130 performs the corresponding first testing procedure to the product to be tested AT1 to test whether a processing unit (for example, a microcontroller) of the product to be tested AT1 normally operates, whether a network function thereof is normal, whether hardware thereof normally operates, whether a line connection thereof is normal, a memory volume, and whether read and write operations of the memory unit thereof are normal, etc., though the invention is not limited thereto. From another aspect, the various first items to be tested in the first testing procedure are, for example, items that are less likely to be tested by the operator in a manual testing approach. Regarding the products to be tested AT1-ATn, the processing unit 130 could perform the first testing procedure to respectively test the first items to be tested of each of the products to be tested AT1-ATn, and details thereof would not be repeated.

In an embodiment, the operator could also perform a manual testing procedure to each of the products to be tested AT1-ATn while the testing apparatus 100 performs the first testing procedure to each of the products to be tested AT1-ATn, so as to test a plurality of second items to be tested of each of the products to be tested AT1-ATn. The second items to be tested are, for example, a key test, a display test of a liquid crystal display (LCD), a light-emitting test of a light-emitting diode (LED), a headphone test, an earphone test, etc. For example, when the operator performs the manual testing procedure to the product to be tested AT1, the operator could test whether the keys or the product to be tested AT1 are normal, whether the LCD thereof has display abnormity, whether a light-emitting status of the LED is normal, whether a sound receiving/playing status of the headphone is normal, whether a sound playing status of the earphone thereof is normal, etc., though the invention is not limited thereto. From another aspect, each of the second items to be tested in the manual testing procedure is, for example, an item tested by the operator in the manual testing approach. Regarding the products to be tested AT1-ATn, the operator could perform the manual testing procedure to respectively test the second items to be tested of each of the products to be tested AT1-ATn, and details thereof are not repeated.

Regarding a single product to be tested (for example, the product to be tested AT1), since a time (which is referred to as a first time) required by the processing unit 130 for finishing the first testing procedure is generally less than a time (which is referred to as a second time) required by the operator for finishing the manual testing procedure on the product to be tested, when the processing unit 130 and the operator simultaneously perform the first testing procedure and the manual testing procedure to the product to be tested, the whole testing flow could be finished within the second time. In other words, since the first testing procedure (which could be regarded as a testing behaviour automatically performed by the testing apparatus 100) and the manual testing procedure (which could be regarded as a testing behaviour manually performed by the operator) of the product to be tested are performed in a parallel approach, the time required for finishing the whole testing flow is reduced. Further, when one product to be tested is tested according to the conventional method, since one of the automatic testing behaviour and the manual testing behaviour could be performed only after another one is finished, the time required for finishing the whole testing flow of the product to be tested is a sum of the first time and the second time. From another aspect, compared to the conventional testing flow, the method for testing product of the invention may save the first time when testing a single product to be tested.

Then, in step S230, when the first testing procedure corresponding to the products to be tested AT1-ATn and the manual testing procedure of each of the products to be tested AT1-ATn are finished, the processing unit 130 reports a testing result of the products to be tested AT1-ATn. For example, the processing unit 130 may present the testing result of the products to be tested AT1-ATn through the user interface 110. The aforementioned testing result is, for example, a testing result of the first items to be tested and the second items to be tested, though the invention is not limited thereto.

In other embodiments, when the testing apparatus 100 performs the first testing procedure to each of the products to be tested AT1-ATn, the first testing procedure could be performed through different implementations, and n=3 is taken as an example for descriptions.

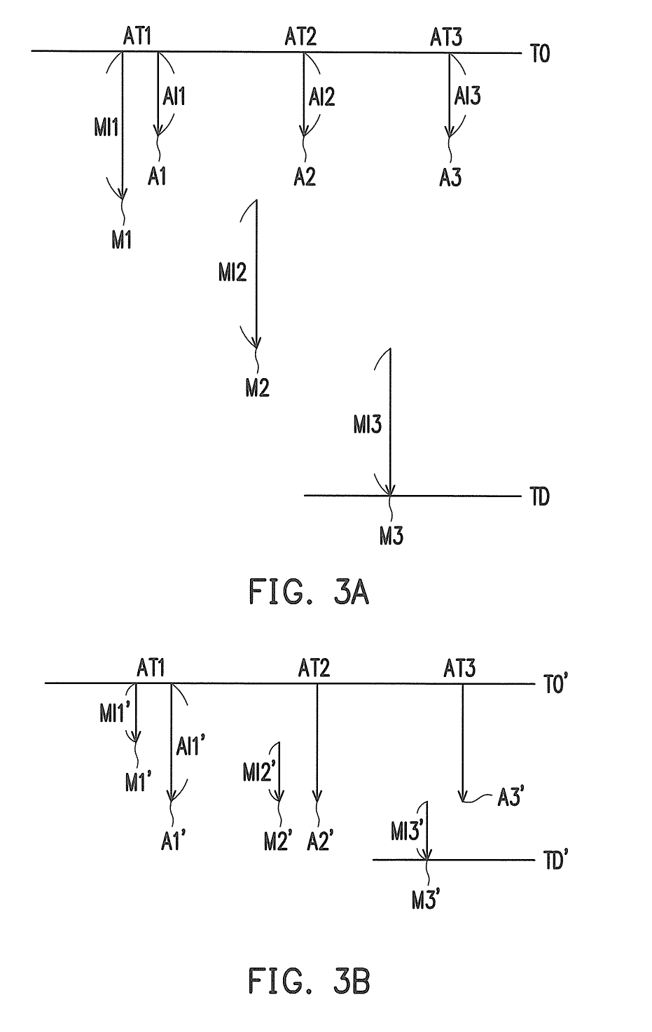

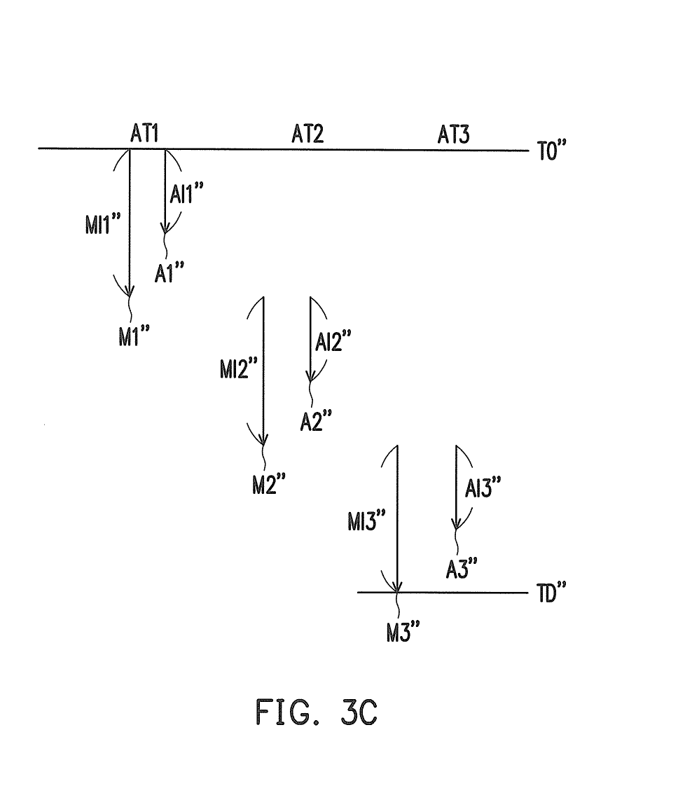

FIG. 3A is a schematic diagram of performing the first testing procedure and the manual testing procedure corresponding to the product to be tested according to an embodiment of the invention. In the present embodiment, when the testing apparatus 100 receives the test starting command CMD at a time point T0, the processing unit 130 simultaneously starts first testing procedures A1-A3 corresponding to the products to be tested AT1-AT3. It is assumed that the time required by the processing unit 130 for performing the first testing procedures A1-A3 are respectively first time AI1-AI3, and the time required by the operator for performing manual testing procedures M1-M3 to the products to be tested AT1-AT3 are respectively second time MI1-MI3. When only one operator tests the products to be tested AT1-AT3, the operator could finish the manual testing procedures M2 and M3 in succession after finishing the manual testing procedure M1. In this way, the time required for testing the products to be tested AT1-AT3 is only a sum of the second time MI1-MI3 (i.e. a time section from the time point T0 to a time point TD). In other words, a total testing time required by the testing apparatus 100 for performing the first testing procedures A1-A3 to the products to be tested AT1-AT3 and required by the operator for performing the manual testing procedures M1-M3 to the products to be tested AT1-AT3 is equal to a testing time required by the operator for performing the manual testing procedures M1-M3 to the products to be tested AT1-AT3.

Moreover, as shown in FIG. 3A, the first testing procedure A1 and the manual testing procedure M1 of the product to be tested AT1 are at least partially performed simultaneously. Namely, the first time MI1 and the second time AI1 are partially overlapped.

FIG. 3B is a schematic diagram of performing the first testing procedure and the manual testing procedure corresponding to the product to be tested according to an embodiment of the invention. In the present embodiment, when the testing apparatus 100 receives the test starting command CMD at a time point T0′, the processing unit 130 substantially and simultaneously starts the first testing procedures A1′-A3′ corresponding to the products to be tested AT1-AT3. It is assumed that the time required by the processing unit 130 for performing the first testing procedures A1′-A3′ are respectively first time AI1′-AI3′, and the time required by the operator for performing manual testing procedures M1′-M3′ to the products to be tested AT1-AT3 are respectively second time MI1′-MI3′. When only one operator tests the products to be tested AT1-AT3, the operator could finish the manual testing procedures M2′ and M3′ in succession after finishing the manual testing procedure M1′. In the present embodiment, although the first time AI1′-AI3′ are respectively greater than the second time MI1′-MI3′ (i.e. the time required by the processing unit 130 for performing the automatic testing behaviour is more than the time required by the operator for performing the manual testing behaviour), since the processing unit 130 substantially starts the first testing procedures A1′-A3′ simultaneously, considerable time could still be saved. In this way, the time required for testing the products to be tested AT1-AT3 is still a sum of the second time MI1′-MI3′ (i.e. a time section from the time point T0′ to a time point TD′).

FIG. 3C is a schematic diagram of performing the first testing procedure and the manual testing procedure corresponding to the product to be tested according to an embodiment of the invention. In the present embodiment, when the testing apparatus 100 receives the test starting command CMD at a time point T0″, the processing unit 130 sequentially starts the first testing procedures A1″-A3″ corresponding to the products to be tested AT1-AT3. It is assumed that the time required by the processing unit 130 for performing the first testing procedures A1″-A3″ are respectively first time AI1″-AI3″, and the time required by the operator for performing manual testing procedures M1″-M3″ to the products to be tested AT1-AT3 are respectively second time MI1″-MI3″.

For example, the processing unit 130 could perform the first testing procedure A1″ to the product to be tested AT1 at the time point T0″. Meanwhile, the operator could also perform the manual testing procedure M1″ to the product to be tested AT1 at the time point T0″. After the processing unit 130 finishes the first testing procedure A1″, the processing unit 130 waits for the operator to complete the manual testing procedure M1″, and continues to perform the first testing procedure A2″ to the product to be tested AT2. After the processing unit finishes the first testing procedure A2″, the processing unit 130 waits for the operator to complete the manual testing procedure M2″, and continues to perform the first testing procedure A3″ to the product to be tested AT3. After the operator finishes the manual testing procedure M3″, the processing unit 130 reports the testing results of the products to be tested AT1-AT3 through the user interface 110. In this way, the time required for testing the products to be tested AT1-AT3 is still a sum of the second time MI1″-MI3″ (i.e. a time section from the time point T0″ to a time point TD″).

In other embodiments, after the processing unit 130 finishes the first testing procedure A1″, the processing unit 130 could also directly performs the first testing procedure A2″ to the product to be tested AT2. Moreover, after the first testing procedure A2″ is finished, the processing unit 130 could further directly performs the first testing procedure A3″ to the product to be tested AT3.

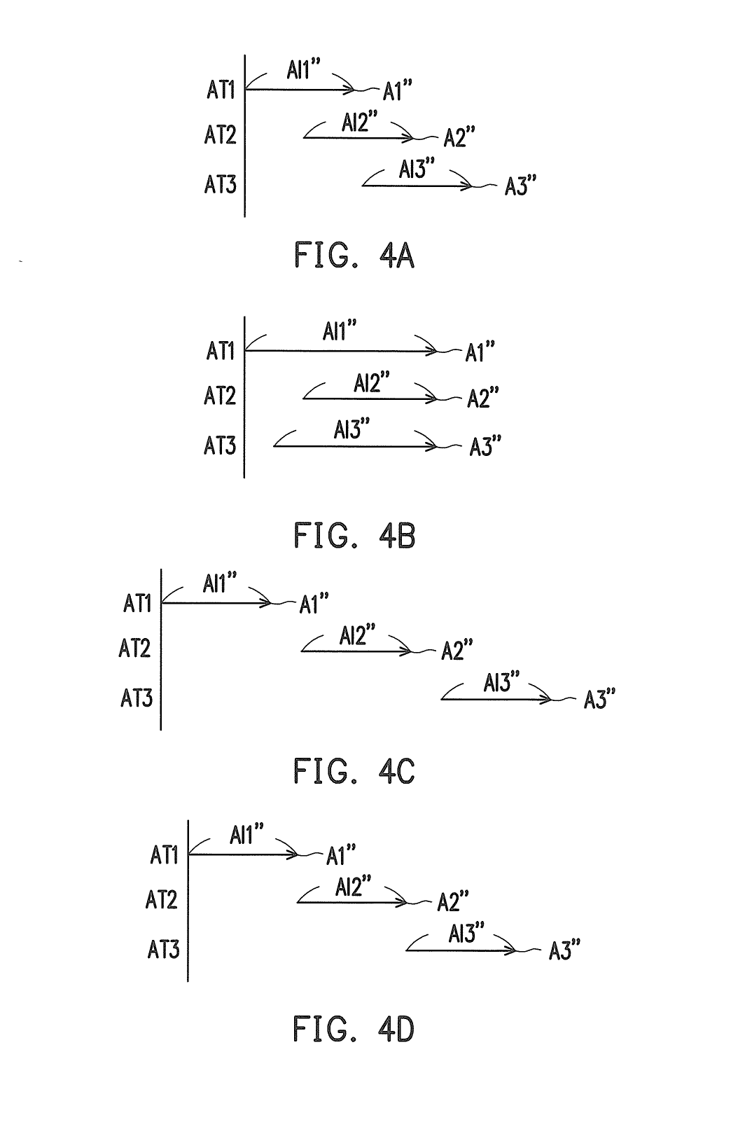

Moreover, the first testing procedures A1″-A3″ sequentially performed by the testing apparatus 100 could be implemented in different ways as that shown in FIG. 4A to FIG. 4D.

FIG. 4A to FIG. 4D are schematic diagrams of sequentially performing the first testing procedure according to a plurality of embodiments of the invention. Referring to FIG. 4A, in the present embodiment, the first testing procedures A1″-A3″ of the products to be tested AT1-AT3 are partially overlapped in timing and are not ended simultaneously. Namely, the first time AI1″ and the first time AI2″ are partially overlapped, and the first time AI2″ and the first time AI3″ are also partially overlapped. Moreover, ending time points of the first testing procedures A1″-A3″ are all different.

Referring to FIG. 4B, in the present embodiment, the first testing procedures A1″-A3″ of the products to be tested AT1-AT3 are partially overlapped in timing and are substantially ended simultaneously. Namely, there are partial time overlapping between the first time AI1″ and AI2″, the first time AI2″ and AI3″, and the first time AI1′ and AI3. Moreover, the first testing procedures A1″-A3″ are all ended at a same time point.

Referring to FIG. 4C, in the present embodiment, the first testing procedures A1″-A3″ of the products to be tested AT1-AT3 are not partially overlapped in timing and are not performed in immediate continuation. Namely, there is no time overlapping between the first time AI1″-AI3″. Moreover, after the first testing procedure A1″ is finished, the first testing procedure A2″ is not immediately performed, instead, the first testing procedure A2″ is performed after a period of time interval. Similarly, after the first testing procedure A2″ is finished, the first testing procedure A3″ is not immediately performed, instead, the first testing procedure A3″ is performed after a period of time interval.

Referring to FIG. 4D, in the present embodiment, the first testing procedures A1″-A3″ of the products to be tested AT1-AT3 are not partially overlapped in timing and are performed in immediate continuation. Namely, there is no time overlapping between the first time AI1″-AI3″. Moreover, after the first testing procedure A1″ is finished, the first testing procedure A2″ is immediately performed. Similarly, after the first testing procedure A2″ is finished, the first testing procedure A3″ is immediately performed.

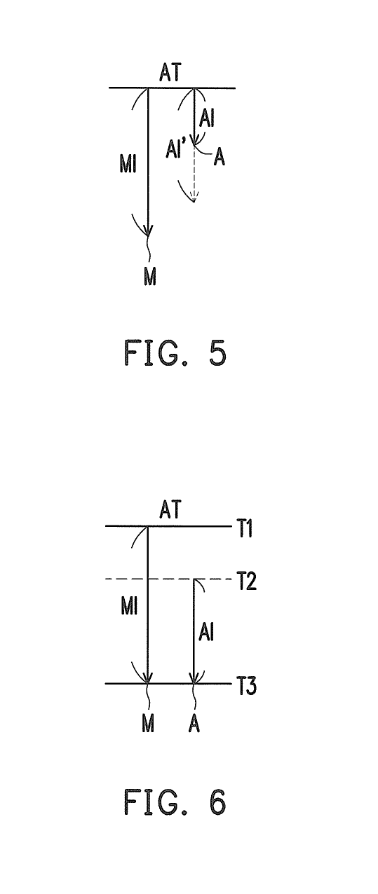

In an embodiment, when the first time required by the first testing procedure corresponding to a product to be tested is smaller than the second time required by the manual testing procedure, the processing unit 130 increases a testing strength of the first items to be tested. FIG. 5 is a schematic diagram of increasing a testing strength of the first items to be tested of the product to be tested according to an embodiment of the invention. In the present embodiment, it is assumed that the testing apparatus 100 of FIG. 1 performs a first testing procedure A (corresponding to a first time AI) to the product to be tested AT to test the first items to be tested of the product to be tested AT. Meanwhile, the operator of the product to be tested AT could also perform a manual testing procedure M (corresponding to a second time MI) to the product to be tested AT. Since the first time AI is smaller than the second time MI, the processing unit 130 could increase a testing strength of each of the first items to be tested of the product to be tested AT. For example, the processing unit 130 could execute a plurality of different testing algorithms to test whether each of the first items to be tested of the product to be tested AT is normal, though implementation of the invention is not limited thereto. When the processing unit 130 increases the testing strength of each of the first items to be tested of the product to be tested AT, the required first time is correspondingly prolonged (the prolonged first time is, for example, a first time AI′). In case that the first time AI′ is not more than the second time MI, the processing unit 130 could test each of the first items to be tested of the product to be tested AT more carefully without increasing the time used for testing the product to be tested AT.

In other embodiments, when the first time AI required by the first testing procedure A is smaller than the second time MI required by the manual testing procedure M, the processing unit 130 could also postpone execution of the first testing procedure A, such that a first ending time point of the first testing procedure A is substantially the same to a second ending time point of the manual testing procedure M. Referring to FIG. 6, FIG. 6 is a schematic diagram of postponing testing of the first items to be tested of the product to be tested according to an embodiment of the invention. In the present embodiment, when the testing apparatus 100 receives the test starting command CMD at a time point T1, the processing unit 130 is postponed to execute the first testing procedure A at a time point T2, such that the first ending time point (for example, a time point T3) of the first testing procedure A is substantially the same to the second ending time point of the manual testing procedure M.

In summary, according to the testing apparatus and the method for testing product of the invention, after the test starting command is received, the first testing procedure is automatically performed to the product to be tested, so as to automatically test the first items to be tested on the product to be tested. Meanwhile, the operator could perform the manual testing procedure to the product to be tested to manually test the second items to be tested on the product to be tested. In this case, since the first testing procedure (which is regarded as a testing behaviour automatically performed by the testing apparatus) and the manual testing procedure (which is regarded as a testing behaviour manually performed by the operator) of the product to be tested are performed in a parallel approach, the time required for finishing the whole testing flow is reduced. Moreover, since the product to be tested is tested in a partial automatic partial manual approach, when the testing apparatus is used for testing different types of the products to be tested, a designer of the testing apparatus only requires to adaptively modify the program codes related to the method of the invention without changing any hardware equipment.

It will be apparent to those skilled in the art that various modifications and variations could be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for testing product, adapted to a testing apparatus, comprising:
receiving a test starting command;
performing a first testing procedure to at least one product to be tested in response to the test starting command to test a plurality of first items to be tested of the at least one product to be tested; and
reporting a testing result of the at least one product to be tested when the first testing procedure corresponding to the at least one product to be tested and a manual testing procedure of the at least one product to be tested are finished, wherein the manual testing procedure of the at least one product to be tested is configured to test a plurality of second items to be tested of the at least one product to be tested

2. The method for testing product as claimed in claim 1, wherein a total testing time required by performing the first testing procedure to the at least one product to be tested and performing the manual testing procedure to the at least one product to be tested is equal to a testing time required by performing the manual testing procedure to the at least one product to be tested.

3. The method for testing product as claimed in claim 1, wherein at least a part of the first testing procedure of the at least one product to be tested and a part of the manual testing procedure of the at least one product to be tested are simultaneously performed.

4. The method for testing product as claimed in claim 1, wherein the step of performing the first testing procedure to the at least one product to be tested in response to the test starting command to test the first items to be tested of the at least one product to be tested comprises:
substantially and simultaneously starting the first testing procedures corresponding to the at least one product to be tested.

5. The method for testing product as claimed in claim 1, wherein the step of performing the first testing procedure to the at least one product to be tested in response to the test starting command to test the first items to be tested of the at least one product to be tested comprises:
sequentially starting the first testing procedures corresponding to the at least one product to be tested.

6. The method for testing product as claimed in claim 5, wherein the first testing procedures of the at least one product to be tested are partially overlapped in timing and are not ended simultaneously.

7. The method for testing product as claimed in claim 5, wherein the first testing procedures of the at least one product to be tested are partially overlapped in timing and are substantially ended simultaneously.

8. The method for testing product as claimed in claim 5, wherein the first testing procedures of the at least one product to be tested are not partially overlapped in timing and are not performed in immediate continuation.

9. The method for testing product as claimed in claim 5, wherein the first testing procedures of the at least one product to be tested are not partially overlapped in timing and are performed in immediate continuation.

10. The method for testing product as claimed in claim 5, wherein the step of sequentially starting the first testing procedures corresponding to the at least one product to be tested comprises:
starting the first testing procedure corresponding to another product to be tested in the at least one product to be tested when the first testing procedure corresponding to one of the at least one product to be tested is finished.

11. The method for testing product as claimed in claim 1, wherein the step of performing the first testing procedure to the at least one product to be tested in response to the test starting command to test the first items to be tested of the at least one product to be tested comprises:
increasing a testing strength of the first items to be tested when a first time required by the first testing procedure is smaller than a second time required by the manual testing procedure.

12. The method for testing product as claimed in claim 1, wherein the step of performing the first testing procedure to the at least one product to be tested in response to the test starting command to test the first items to be tested of the at least one product to be tested comprises:
postponing execution of the first testing procedure such that a first ending time point of the first testing procedure is substantially the same to a second ending time point of the manual testing procedure when a first time required by the first testing procedure is smaller than a second time required by the manual testing procedure.

13. A testing apparatus, comprising:
a user interface, receiving a test starting command;
a storage unit, storing a plurality of program codes;
a processing unit, coupled to the user interface and the storage unit, and configured to access the program codes to execute following steps:
performing a first testing procedure to at least one product to be tested in response to the test starting command to test a plurality of first items to be tested of the at least one product to be tested; and
reporting a testing result of the at least one product to be tested when the first testing procedure corresponding to the at least one product to be tested and a manual testing procedure of the at least one product to be tested are finished, wherein the manual testing procedure of the at least one product to be tested is configured to test a plurality of second items to be tested of the at least one product to be tested.

14. The testing apparatus as claimed in claim 13, wherein a total testing time required by performing the first testing procedure to the at least one product to be tested and performing the manual testing procedure to the at least one product to be tested is equal to a testing time required by performing the manual testing procedure to the at least one product to be tested.

15. The testing apparatus as claimed in claim 13, wherein at least a part of the first testing procedure of the at least one product to be tested and a part of the manual testing procedure of the at least one product to be tested are simultaneously performed.

16. The testing apparatus as claimed in claim 13, wherein the processing unit substantially starts the first testing procedures corresponding to the at least one product to be tested, simultaneously.

17. The testing apparatus as claimed in claim 13, wherein the processing unit sequentially starts the first testing procedures corresponding to the at least one product to be tested.

18. The testing apparatus as claimed in claim 17, wherein when the first testing procedure corresponding to one of the at least one product to be tested is finished, the processing unit starts the first testing procedure corresponding to another product to be tested in the at least one product to be tested.

19. The testing apparatus as claimed in claim 13, wherein when a first time required by the first testing procedure is smaller than a second time required by the manual testing procedure, the processing unit increases a testing strength of the first items to be tested.

20. The testing apparatus as claimed in claim 13, wherein when a first time required by the first testing procedure is smaller than a second time required by the manual testing procedure, the processing unit postpones execution of the first testing procedure such that a first ending time point of the first testing procedure is substantially the same to a second ending time point of the manual testing procedure.
